(19) United States
(12) Patent Application Publication
(10) Pub. No.: US 2013/0258551 A1
(43) Pub. Date: Oct. 3, 2013

(54) CONDUCTIVE PASTE COMPOSITION FOR INTERNAL ELECTRODE AND MULTILAYER CERAMIC ELECTRONIC COMPONENT INCLUDING THE SAME

(71) Applicants: Jong Han KIM, Suwon (KR); Seung Ho Lee, Suwon (KR); Jae Yeol Choi, Suwon (KR); Eung Soo Kim, Suwon (KR)

(72) Inventors: Jong Han KIM, Suwon (KR); Seung Ho Lee, Suwon (KR); Jae Yeol Choi, Suwon (KR); Eung Soo Kim, Suwon (KR)

(73) Assignee: SAMSUNG ELECTRO-MECHANICS CO., LTD.

(21) Appl. No.: 13/532,049

(22) Filed: Jun. 25, 2012

(30) Foreign Application Priority Data
Apr. 2, 2012 (KR) 10-2012-0033876

(51) Int. Cl. H01B 1/02; H01G 4/008; H01G 4/12; B82Y 30/00

(52) U.S. Cl. 361/321.3; 252/512; 252/513; 977/773; 977/810; 977/811

(57) ABSTRACT

There are provided a conductive paste composition for an internal electrode and a multilayer ceramic capacitor including the same. The conductive paste composition for an internal electrode includes metal powder; and chrome oxide (Cr₂O₃) or titanium oxide (TiO₂) powder having a melting point higher than the melting point of the metal powder. The conductive paste composition for an internal electrode may increase a sintering shrinkage temperature of the internal electrode and improve connection properties of the internal electrode.

### CROSS-REFERENCE TO RELATED APPLICATIONS

This application claims the priority of Korean Patent Application No. 10-2012-0033876 filed on Apr. 2, 2012, in the Korean Intellectual Property Office, the disclosure of which is incorporated herein by reference.

### BACKGROUND OF THE INVENTION

1. Field of the Invention

The present invention relates to a conductive paste composition for an internal electrode and a multilayer ceramic electronic component including the same, and more particularly, to a conductive paste composition for an internal electrode allowing for sintering shrinkage of a metal powder to be controlled, and a multilayer ceramic electronic component including the same.

2. Description of the Related Art

In general, an electronic component using ceramic materials such as a capacitor, an inductor, a piezoelectric diode, a varistor, a thermistor or the like is provided with a ceramic main body formed of the ceramic material, an internal electrode layer formed in the main body, and external electrodes installed on surfaces of the ceramic main body so as to be connected to the internal electrodes.

A multilayer ceramic capacitor of the ceramic electronic components includes a plurality of laminated dielectric layers, internal electrode layer disposed to face each other while having one dielectric layer interposed therebetween, and external electrodes electrically connected to the internal electrodes.

The multilayer ceramic capacitor is extensively used as a component in mobile communications devices such as portable computers, PDAs and mobile phones due to strengths thereof such as small size, guaranteed high capacity, and ease of mountability.

Recently, as electronic products have been reduced in size and have developed multifunctionality, chip components have also become compact and highly multifunctional, such that a multilayer ceramic capacitor (MLCC) product which is small but has a high capacity is in demand.

Particularly, according to progress in high speed central processing units(CPUs), reductions in size and weight, digitalization, and high performance in devices, research and development for implementing characteristics such as size reductions, slimness, high capacitance, and low impedance in a high frequency region of a multilayer ceramic capacitor (hereinafter, referred to as ‘MLCC’) have been actively undertaken.

A multilayer ceramic capacitor may be manufactured by laminating ceramic green sheets having conductive paste internal electrode patterns provided thereon and performing simultaneous sintering thereof.

However, in order to appropriately form the dielectric layer, the ceramic green sheet maybe sintered at a temperature of about 1100° C. or more, while the conductive paste may be sintered and shrink at a relatively low temperature.

Accordingly, over-sintering of the internal electrode layer may occur during sintering of the ceramic green sheet, such that the internal electrode layer may be agglomerated or broken and internal electrode connectivity may be reduced.

A related art document discloses a nickel powder for an internal electrode including chrome in order to solve the aforementioned defects, but has a defect in that an effect thereof in preventing low temperature sintering shrinkage of the conductive paste may not be significant.

### RELATED ART DOCUMENT

Japanese Patent Laid-Open Publication No. 2007-042688

### SUMMARY OF THE INVENTION

An aspect of the present invention provides a conductive paste composition for an internal electrode, allowing for sintering shrinkage of a metal powder to be controlled, and a multilayer ceramic electronic component including the same.

According to an aspect of the present invention, there is provided a conductive paste composition for an internal electrode of a multilayer ceramic electronic component, including: a metal powder; and a chrome oxide (Cr₂O₃) or titanium oxide (TiO₂) powder having a melting point higher than the melting point of the metal powder.

A content of the Cr₂O₃ or TiO₂ powder having the melting point higher than the melting point of the metal powder may be 1 to 20 parts by weight based on 100 parts by weight of the metal powder.

The metal powder may be one or more selected from the group consisting of Nickel (Ni), manganese (Mn), chromium (Cr), cobalt (Co), aluminum (Al) and alloys thereof.

An average grain diameter of the metal powder may be 50 to 400 nm.

An average grain diameter of the Cr₂O₃ or TiO₂ powder having the melting point higher than the melting point of the metal powder may be 10 to 100 nm.

According to another aspect of the present invention, there is provided a conductive paste composition for an internal electrode of a multilayer ceramic electronic component, including: a metal powder; and a chrome (Cr—Cr₂O₃) or titanium (Ti—TiO₂) powder having a melting point higher than the melting point of the metal powder and an oxidized surface.

A content of the Cr—Cr₂O₃ or Ti—TiO₂ powder having the melting point higher than the melting point of the metal powder and the oxidized surface may be 1 to 20 parts by weight based on 100 parts by weight of the metal powder.

The metal powder may be one or more selected from the group consisting of Ni, Mn, Cr, Co, Al and alloys thereof.

An average grain diameter of the metal powder may be 50 to 400 nm.

An average grain diameter of the Cr—Cr₂O₃ or Ti—TiO₂ powder having the melting point higher than the melting point of the metal powder and the oxidized surface may be 10 to 100 nm.

According to another aspect of the present invention, there is provided a multilayer ceramic electronic component including: a ceramic main body; and an internal electrode layer formed in the ceramic main body, wherein the internal electrode layer includes a Cr₂₀₃ or TiO₂ powder trapped therein, the Cr₂₀₃ or TiO₂ powder having a melting point higher than the melting point of metal powder forming the internal electrode layer.

The Cr₂O₃ or TiO₂ powder having the melting point higher than the melting point of the metal powder may be trapped in an interface of metal powder grains forming the internal electrode layers.

The internal electrode layer may include a metal layer formed by reducing a portion of the Cr₂O₃ or TiO₂ powder having the melting point higher than the melting point of the metal powder, in one surface thereof.

The internal electrode layer may be formed by a conductive paste including the metal powder and the Cr₂O₃ or TiO₂ powder having an average grain diameter that is smaller than the average grain diameter of the metal powder and the melting point higher than the melting point of the metal powder.

The ceramic main body and the internal electrode layer may be simultaneously sintered.

According to another aspect of the present invention, there is provided a multilayer ceramic electronic component including: a ceramic main body; and an internal electrode layer formed in the ceramic main body, wherein the internal electrode layer includes a Cr—Cr₂O₃ or Ti—TiO2 powder trapped therein, the Cr—Cr₂O₃ or Ti—TiO2 powder having a melting point higher than the melting point of metal powder forming the internal electrode layer and an oxidized surface.

The Cr—Cr₂O₃ or Ti—TiO2 powder having the melting point higher than the melting point of the metal powder and having the oxidized surface may be trapped in an interface of metal powder grains forming the internal electrode layers.

The internal electrode layer may include a metal layer formed by reducing a portion of the Cr—Cr₂O₃ or Ti—TiO2 powder having the melting point higher than the melting point of the metal powder and having the oxidized surface, in one surface thereof.

The internal electrode layer may be formed by a conductive paste including the metal powder and the Cr—Cr₂O₃ or Ti—TiO2 powder having an average grain diameter that is smaller than the average grain diameter of the metal powder, the melting point higher than the melting point of the metal powder, and the oxidized surface.

The ceramic main body and the internal electrode layer may be simultaneously sintered.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a multilayer ceramic capacitor according to an embodiment of the present invention;

FIG. 2 is a schematic cross-sectional view illustrating the multilayer ceramic capacitor taken along line A-A′ of FIG. 1;

FIG. 3 is a partially enlarged view schematically illustrating an internal electrode according to the embodiment of the present invention; and

FIGS. 4A and 4B are mimetic diagrams schematically illustrating dynamics of sintering shrinkage of a conductive paste for an internal electrode according to the embodiment of the present invention.

### DETAILED DESCRIPTION OF THE EMBODIMENTS

Hereainafter, embodiments of the present invention will now be described in detail with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

An embodiment of the present invention relates to a ceramic electronic component, examples of the electronic component using ceramic materials include a capacitor, an inductor, a piezoelectric diode, a varistor, a thermistor or the like, and a multilayer ceramic capacitor, as an example of the ceramic electronic component, will be described below.

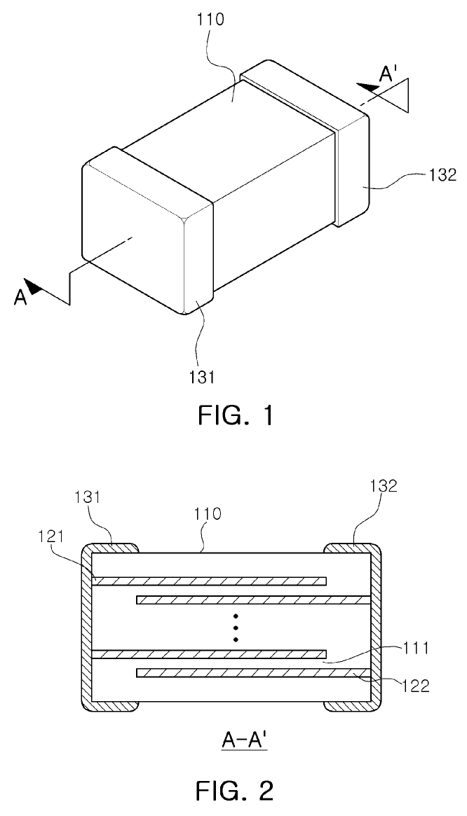

FIG. 1 is a schematic perspective view illustrating a multilayer ceramic capacitor according to an embodiment of the present invention, and FIG. 2 is a schematic cross-sectional view illustrating the multilayer ceramic capacitor taken along line A-A′ of FIG. 1.

With reference to FIGS. 1 and 2, the multilayer ceramic capacitor according to the present embodiment may include a ceramic main body 110, internal electrodes 121 and 122 formed in the ceramic main body, and external electrodes 131 and 132 formed on external surfaces of the ceramic main body 110.

The shape of the ceramic main body 110 is not particularly limited, but, in general, may be a rectangular parallelepiped shape. Further, the dimensions thereof are not particularly limited, but, for example, maybe 0.6 mm×0.3 mm, forming a high lamination and high-capacitive multilayer ceramic capacitor of 2.2 μF or more.

The ceramic main body 110 may be formed by laminating a plurality of dielectric layers 111. When sintered, a plurality of dielectric layers 111 constituting the ceramic main body 110 and adjacent dielectric layers may basically be united, such that boundaries thereof may not be readily confirmed.

The dielectric layer 111 may be formed by sintering a ceramic green sheet including ceramic powder.

The ceramic powder is not particularly limited as long as the ceramic powder is generally used in the art. The ceramic powder may, for example, include a BaTiO₃-based ceramic powder, but is not limited thereto. The BaTiO₃-based ceramic powder is not limited thereto, and for example, examples thereof may include (Ba₁₋ₓCaₓ)TiO₃, Ba (Ti_{1-y}Ca_{y})O₃, (Ba₁₋ₓCaₓ) (Ti_{1-y}Zr_{y})O₃ or Ba (Ti_{1-y}Zr_{y})O₃ where Ca, Zr or the like is partially used in BaTiO₃ or the like. The average grain diameter of the ceramic powder is not particularly limited, but, for example, may be 1.0 μm or less.

Further, the ceramic green sheet may include ceramic powder, a transition metal, a rare earth element, Mg, Al or the like.

The thickness of one dielectric layer 111 may be appropriately changed according to a capacitance design of the multilayer ceramic capacitor. For example, the thickness of the dielectric layer 111 formed between the adjacent internal electrodes 121 and 122 may be 1.0 μm or less after sintering, but is not limited thereto.

The internal electrodes 121 and 122 may be formed in the ceramic main body 110. The internal electrodes 121 and 122 may be formed on one dielectric layer to be laminated, and may be formed in the ceramic main body 110 while one dielectric layer is interposed therebetween by sintering.

A pair of a first internal electrode 121 and a second internal electrode 122 having different polarities may be set as the internal electrodes, and may be disposed to face each other in the lamination direction of the dielectric layer. Terminals of the first and second internal electrodes 121 and 122 may be alternately exposed to end surfaces of the ceramic main body 110.

The thickness of each of the internal electrodes 121 and 122 may be appropriately determined according to the intended purpose of the MLCC, and for example, the thickness thereof may be 1.0 μm or less. Alternatively, the thickness may be selected to be within the range of 0.1 to 1.0 μm.

The internal electrodes 121 and 122 may be formed of the conductive paste for the internal electrode according to the embodiment of the present invention. The conductive paste composition for the internal electrode according to the embodiment of the present invention may include a metal powder; and high melting point chrome oxide (Cr₂O₃) or titanium oxide (TiO₂) powder, or chrome (Cr—Cr₂O₃) or titanium (Ti—TiO₂) powder having an oxidized surface. A more specific description thereof will be given below.

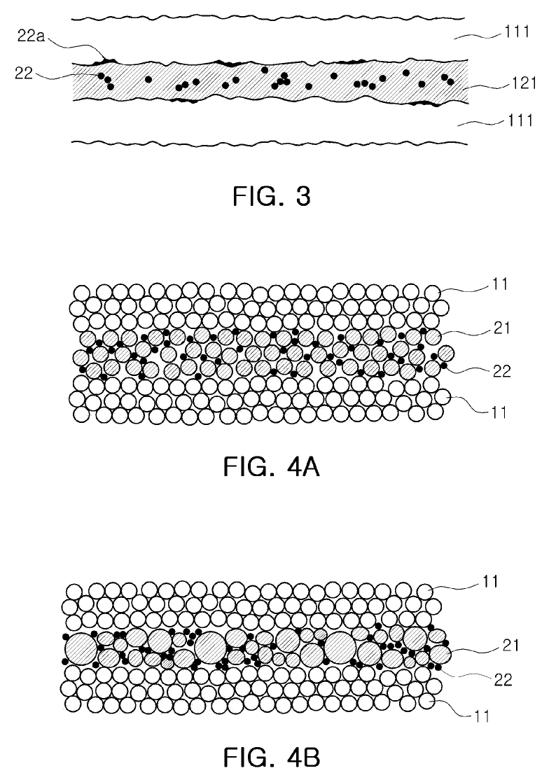

FIG. 3 is a partially enlarged view schematically illustrating the internal electrode 121 according to the embodiment of the present invention. With reference to FIG. 3, the internal electrode 121 according to the embodiment of the present invention may include high melting point Cr₂O₃ or TiO₂ powder, or chrome (Cr—Cr₂O₃) or titanium (Ti—TiO₂) powder having the oxidized surface, trapped in the internal electrode.

The high melting point Cr₂O₃ or TiO₂ powder, or chrome (Cr—Cr₂O₃) or titanium (Ti—TiO₂) powder 22 having the oxidized surface may be trapped in boundaries between metal grains, that is, grain boundaries, within the internal electrodes.

The high melting point Cr₂O₃ or TiO₂ powder, or chrome (Cr—Cr₂O₃) or titanium (Ti—TiO₂) powder 22 having the oxidized surface have a melting point higher than that of the metal powder forming the internal electrode, and may be trapped in the boundaries of metal grains during a sintering process of the metal powder.

Further, in one region of one surface of the internal electrode 121, that is, in one region of the boundaries of the dielectric layer 111 and the internal electrode 121, a metal layer 22a formed by reducing a portion of high melting point Cr₂O₃ or TiO₂ powder, or chrome (Cr—Cr₂O₃) or titanium (Ti—TiO₂) powder having the oxidized surface may be formed.

Bonding strength between the internal electrode and the dielectric layer may be reinforced by the partially reduced high melting point metal layer 22a.

The partially reduced high melting point metal layer 22a may act as a conductor, such that a reduction in capacity of the multilayer ceramic capacitor may only barely occur.

This will be more apparent in a process of forming the conductive paste composition for the internal electrode and the internal electrode to be described below.

According to the embodiment of the present invention, external electrodes 131 and 132 may be formed on external surfaces of the ceramic main body 110, and the external electrodes 131 and 132 may be electrically connected to the internal electrodes 121 and 122. To be more specific, it may be constituted by a first external electrode 131 electrically connected to the first internal electrode 121 exposed to one end surface of the ceramic main body 110, and a second external electrode 132 electrically connected to the second internal electrode 122 exposed to another surface of the ceramic main body 110.

Further, although not shown in the drawings, the first and second internal electrodes may be exposed to at least one or more surfaces of the ceramic main body. Further, the first and second internal electrodes may be exposed to the same surface of a ceramic main body.

The external electrodes 131 and 132 may be formed of the conductive paste including a conductive material. The conductive material included in the conductive paste is not particularly limited, but, for example, Ni, Cu, or alloys thereof may be used. The thicknesses of the external electrodes 131 and 132 may be appropriately determined according to the intended purpose of the MLCC or the like, and for example, the thicknesses thereof may be 10 to 50 μm.

Hereinafter, the conductive paste composition for the internal electrode of the multilayer ceramic electronic component according to the embodiment of the present invention will be described.

FIGS. 4A and 4B are mimetic diagrams schematically illustrating dynamics of sintering shrinkage of a conductive paste for an internal electrode according to the embodiment of the present invention, and a description will be given with reference thereto.

The conductive paste composition for the internal electrode according to the embodiment of the present invention may include metal powder 21; and chrome oxide (Cr₂O₃) or titanium oxide (TiO₂) powder 22 having a melting point higher than the melting point of the metal powder.

The conductive paste composition for the internal electrode according to the embodiment of the present invention may increase a sintering shrinkage temperature of the internal electrode and may improve connection properties of the internal electrode.

The kind of the metal powder 21 included in the conductive paste composition is not particularly limited, and for example, base metal may be used.

The conductive paste composition may, for example, be Ni, Mn, Cr, Co, Al or alloys thereof, and may include one or more thereof, but is not limited thereto.

Further, the average grain diameter of the metal powder 21 is not particularly limited, but, for example, may be 400 nm or less.

Specifically, the average grain diameter of the metal powder 21 may be 50 to 400 nm.

The Cr₂O₃ or TiO₂ powder 22 included in the conductive paste composition may have a melting point higher than that of the metal powder 21.

As the powder, for example, one or more kinds of metal oxides may be used, but it is not limited thereto.

The Cr₂O₃ or TiO₂ powder 22 may have an average grain diameter that is smaller than that of the metal powder 21.

The average grain diameter of the Cr₂O₃ or TiO₂ powder may, for example, be 10 to 100 nm, but is not limited thereto.

The chrome oxide (Cr₂O₃) or titanium oxide (TiO₂) powder 22 may be distributed between the metal powder grains 21 by using the Cr₂O₃ or TiO₂ powder 22 having the average grain diameter that is smaller than that of the metal powder 21.

The Cr₂O₃ or TiO₂ powder 22 may delay an initiation temperature of sintering shrinkage of the metal powder 21 and suppress sintering shrinkage of the metal powder 21.

To be more specific, the Cr₂O₃ or TiO₂ powder 22 may prevent metal powder grains from coming into contact with each other during sintering shrinkage of the metal powder 21, thus suppressing a grain growth in the metal powder.

Particularly, powder added to suppress sintering shrinkage of the metal powder 21 may be used in an oxide form rather than in a metal form of chrome (Cr) or titanium (Ti).

For example, the melting point of chrome (Cr) is about 1890° C., while the melting point of titanium (Ti) is about 1668° C., but in the case of oxides thereof, in the case of chrome oxide (Cr₂O₃), the melting point is about 2435° C., and in the case of titanium oxide (TiO₂), the melting point is about 1843° C., higher than the melting point of the metal form.

Accordingly, it may be seen that the oxide form thereof may be relatively more effective to suppress sintering shrinkage of the metal powder 21.

Further, since sintering is performed in a reduction atmosphere, the oxide powder remains in a metal form in the electrode, such that, as described above, it may be relatively more effective to add the powder in an oxide form in order to suppress sintering shrinkage.

According to the embodiment of the present invention, the content of Cr₂O₃ or TiO₂ powder 22 may be 1 to 20 parts by weight based on 100 parts by weight of the metal powder 21.

In the case in which the content of Cr₂O₃ or TiO₂ powder 22 is less than 1 part by weight, it can be seen that connection properties of the electrode may be reduced, and in the case in which the content of Cr₂O₃ or TiO₂ powder 22 is more than 20 parts by weight, it can be seen that the amount of metal oxide present at an interface between the internal electrode and the dielectric layer may be increased to reduce capacitance.

The conductive paste composition for the internal electrode according to the embodiment of the present invention may further include a dispersing agent, a binder, a solvent and the like.

Non-limiting but illustrative examples of the binder may include polyvinylbutyral, cellulose-based resins and the like. Polyvinylbutyral has strong adhesive properties, and may improve adhesion strength between the conductive paste for the internal electrode and the ceramic green sheet.

The cellulose-based resin has a chair-type structure, and in the case in which deformation occurs, the cellulose-based resin is characterized in that recovery due to elasticity is relatively rapid. A flat printing surface maybe secured by the inclusion of the cellulose resin.

The solvent is not particularly limited, and for example, butylcarbitol, kerosene or terpineol-based solvents may be used.

In general, the conductive paste composition for the internal electrode may be printed on the ceramic green sheet and sintered simultaneously with the ceramic green sheet after a process such as lamination is performed.

Further, in the case in which a base metal is used as the internal electrode, when sintering is performed in atmospheric air, the internal electrode may be oxidized.

Accordingly, simultaneous sintering of the ceramic green sheet and the internal electrode may be performed in a reduction atmosphere.

The dielectric layer of the multilayer ceramic capacitor may be formed by sintering the ceramic green sheet at a temperature of about 1100° C. or more.

In the case in which a base metal such as Ni is used in the internal electrode, oxidizing occurs from a temperature of about 400° C. to thereby cause sintering shrinkage, and rapid sintering may occur at 1000° C. or more. When the internal electrode is rapidly sintered, the electrode may be agglomerated or broken due to over-sintering of the internal electrode, and connection properties and capacity of the internal electrode may be reduced. Further, after sintering, internal structural defects within the multilayer ceramic capacitor, such as cracks, may be formed.

Accordingly, a difference in a shrinkage ratio with the dielectric layer needs to be significantly reduced by significantly delaying the sintering initiation temperature of the metal powder that starts to be sintered at a relatively low temperature of 400 to 500° C.

FIGS. 4A and 4B are mimetic diagrams schematically illustrating dynamics of sintering shrinkage of a conductive paste for an internal electrode according to the embodiment of the present invention. FIG. 4A illustrates an initial period of the sintering process before sintering shrinkage of the metal powder 21 is initiated, and FIG. 4B schematically illustrates a state in which sintering shrinkage of the metal powder 21 is performed by increasing the temperature.

The dielectric layer 111, as illustrated in FIG. 2, may be formed from the ceramic powder 11 through the sintering process in FIGS. 4A and 4B.

With reference to FIGS. 4A and 4B, at an initial process of the sintering process, the metal powder 21 may be shrunken and Cr₂O₃ or TiO₂ powder 22 may escape from between the metal powder grains to move toward the ceramic powder 11.

In general, before the ceramic powder is shrunken, the metal powder may be sintered to form the internal electrode, and the internal electrode may be agglomerated during a shrinkage process of the ceramic powder to reduce the connection properties of the internal electrode.

However, according to the embodiment of the present invention, when the Cr₂O₃ or TiO₂ fine grain powder 22 having the sintering temperature that is higher than that of the metal powder 21 is well dispersed within the metal powder 21, sintering initiation of the metal powder 21 may be suppressed to about 1000° C. or more. The sintering of the metal powder 21 is relatively more suppressed to about 1000 C, and the sintering of the ceramic powder 11 may be initiated.

When densification of the ceramic powder 11 is performed, densification of the internal electrode is initiated and sintering may be rapidly performed. In this case, when the temperature increase rate is controlled, the Cr₂O₃ or TiO₂ powder 22 may not escape from between the metal powder grains but be trapped in the grain boundaries of the metal powder 21 as shown in FIG. 3 to hinder a grain growth of the metal powder 21. Accordingly, an agglomeration phenomenon in the internal electrode may be suppressed to increase connection properties of the internal electrode.

Further, a portion of the Cr₂O₃ or TiO₂ powder 22 may be moved to the surface of the internal electrode and distributed in a small amount at an interface between the dielectric layer 111 and the internal electrode 121. However, since the frequency thereof is relatively small, a dielectric property may not be reduced. Further, even in a case in which the high melting point metal oxide is present at the interface between the dielectric layer 111 and the internal electrode 121, since the connection properties of the electrode may be excellent, an effective electrode area may be increased.

Further, in the case in which the sintering is performed in the reduction atmosphere, the Cr₂O₃ or TiO₂ powder 22, present at the interface maybe partially reduced into the metal according to the controlling of the reduction atmosphere to form the metal layer 22a. The reduction form of the Cr₂O₃ or TiO₂ powder 22 into metal may be metal such as Cr, Ti, or the like.

The metal layer 22a in which a portion of the Cr₂O₃ or TiO₂ powder is reduced may act as the conductor according to the content ratio of metal, and when the content of the Cr₂O₃ or TiO₂ powder is controlled, a reduction in capacity of the multilayer ceramic capacitor may hardly occur.

According to the recent size-reduction and weight-reduction of the multilayer ceramic capacitor, the internal electrode is thinned. A metal powder having finer particles maybe used to form the internal electrode of the thin layer, but in this case, it may be difficult to control sintering shrinkage of the metal powder and ensure connection properties of the internal electrode.

However, according to the embodiment of the present invention, as described above, an effect of sintering shrinkage suppression in the metal powder forming the internal electrode maybe obtained by including the Cr₂O₃ or TiO₂ powder having the melting point higher than that of the metal powder in the conductive paste for the internal electrode.

Further, the the Cr₂O₃ or TiO₂ powder may be trapped in the internal electrode to improve the connection properties of the internal electrode, thus allowing the internal electrode to be relatively thinner.

A conductive paste composition for an internal electrode according to another embodiment of the present invention may include metal powder; and chrome (Cr—Cr₂O₃) or titanium (Ti—TiO₂) powder having a melting point higher than that of the metal powder and an oxidized surface.

The conductive paste composition for the internal electrode according to another embodiment of the present invention has the same characteristics as the aforementioned conductive paste composition for the internal electrode according to the embodiment of the present invention, except that the conductive paste composition for the internal electrode according to another embodiment of the present invention includes the Cr—Cr₂O₃ or Ti—TiO2 powder having the melting point higher than that of the metal powder and the oxidized surface, and thus is omitted herein.

Hereinafter, a method of manufacturing a multilayer ceramic capacitor according to another embodiment of the present invention will be described.

According to the embodiment of the present invention, a plurality of ceramic green sheets may be prepared. The ceramic green sheet may be manufactured by manufacturing a slurry by mixing ceramic powder, a binder, a solvent and the like, and shaping the slurry into a sheet having a thickness of several elm by a doctor blade method. Thereafter, the ceramic green sheet may be sintered to form a dielectric layer 111 as shown in FIG. 2.

Next, an internal electrode pattern may be formed by applying the conductive paste for the internal electrode to the ceramic green sheet. The internal electrode pattern may be formed by a screen printing method or a gravure printing method.

The conductive paste composition for the internal electrode may be used by using a matter according to the embodiment of the present invention, and specific components and contents are the same as the aforementioned components and contents.

Thereafter, a plurality of ceramic green sheets may be laminated and pressed in a lamination direction to compress the ceramic green sheets with the internal electrode paste laminated thereon. Thereby, a ceramic laminate in which the ceramic green sheet and the internal electrode are alternately laminated may be manufactured.

Next, the ceramic laminate may be formed into chips by cutting the ceramic laminate into portions respectively corresponding to a single capacitor. In this case, the cutting maybe performed so that ends of the internal electrode pattern are alternately exposed through end surfaces. Thereafter, a ceramic main body may be manufactured by sintering the laminate portions formed into the chips. As described above, the sintering process may be performed in a reduction atmosphere.

Further, the sintering process may be performed by controlling the temperature increase rate. The temperature increase rate may be 30° C./60s to 50° C./60s, but is not limited thereto.

Next, external electrodes may be formed so as to cover the end surfaces of the ceramic main body and be electrically connected to the internal electrodes exposed to the end surface of the ceramic main body. Thereafter, a plating treatment of nickel, tin or the like may be performed on the surface of the external electrode.

As described above, the Cr₂O₃ or TiO₂ powder, or the Cr—Cr₂O₃ or Ti—TiO2 powder 22 having the oxidized surface may be trapped in the grain boundaries of the internal electrode 121, such that the connection properties of the internal electrode may be improved.

Further, in one region of the interface of the dielectric layer 111 and the internal electrode 121, a metal layer 22a obtained by reducing a portion of Cr₂O₃ or TiO₂ powder, or chrome (Cr—Cr₂O₃) or titanium (Ti—TiO₂) powder having the oxidized surface may be formed. The partially reduced metal layer 22a may act as a conductor, such that a reduction in capacity in the multilayer ceramic capacitor may barely occur.

According to the embodiment of the present invention, the conductive paste composition for the internal electrode was manufactured, and the multilayer ceramic capacitor was manufactured using the same. In the conductive paste composition, nickel powder was used as the metal powder, and the specific kind and content of high melting point metal oxides are described in the following Table 1.

[Evaluation]

The electrode connection properties of the multilayer ceramic capacitor are a value obtained by calculating a ratio of a length of the internal electrode other than voids to an entire length of the internal electrode in one cross section of the internal electrode, evaluated based on the following criteria, and described in the following Table 1.

⊚: Very favorable (electrode connection properties of 85% or more)

∘: Favorable (electrode connection properties of 75% or more and less than 85%)

×: Poor (electrode connection properties of less than 75%)

The electric properties of the multilayer ceramic capacitor were obtained by evaluating whether internal voltage properties such as target capacity, DF and BDV, IR and an accelerated lifespan were implemented. The electric properties were measured with respect to 100 chips, evaluated based on the following criteria according to the number of chips suitable to the criteria, and described in the following Table 1.

⊚: Very favorable (amount of chips matching criteria 85 or more)

∘: Favorable (amount of chips matching criteria 75 or more and less than 85)

×: Poor (amount of chips matching criteria less than 75)

TABLE 1

| | | Contents | Electrode | |
|---|---|---|---|---|
| | High melting point | (parts by | connection | Electric |
| Sample | metal oxide | weight/Ni) | properties(%) | properties |
| 1* | Cr₂O₃ | 0.7 | X | X |
| 2 | Cr₂O₃ | 1.0 | ◯ | ⊚ |
| 3 | Cr₂O₃ | 10 | ◯ | ◯ |
| 4 | Cr₂O₃ | 20 | ⊚ | ◯ |
| 5* | Cr₂O₃ | 25 | ⊚ | X |
| 6* | surface oxidation | 0.7 | X | X |
| | Cr—Cr₂O₃ | | | |
| 7 | surface oxidation | 1.0 | ◯ | ⊚ |
| | Cr—Cr₂O₃ | | | |
| 8 | surface oxidation | 10 | ◯ | ◯ |
| | Cr—Cr₂O₃ | | | |
| 9 | surface oxidation | 20 | ⊚ | ◯ |
| | Cr—Cr₂O₃ | | | |
| 10* | surface oxidation | 25 | ⊚ | X |
| | Cr—Cr₂O₃ | | | |
| 11* | TiO₂ | 0.7 | X | X |
| 12 | TiO₂ | 1.0 | ◯ | ⊚ |
| 13 | TiO₂ | 10 | ◯ | ◯ |
| 14 | TiO₂ | 20 | ⊚ | ◯ |
| 15* | TiO₂ | 25 | ⊚ | X |
| 16* | surface oxidation | 0.7 | X | X |
| | Ti—TiO₂ | | | |
| 17 | surface oxidation | 1.0 | ◯ | ⊚ |
| | Ti—TiO₂ | | | |
| 18 | surface oxidation | 10 | ◯ | ◯ |
| | Ti—TiO₂ | | | |
| 19 | surface oxidation | 20 | ⊚ | ◯ |
| | Ti—TiO₂ | | | |
| 20* | surface oxidation | 25 | ⊚ | X |
| | Ti—TiO₂ | | | |

With reference to Table 1, the content was controlled according to the kind of high melting point metal oxide powder, and when the content of the Cr₂O₃ or TiO₂ powder, or chrome (Cr—Cr₂O₃) or titanium (Ti—TiO₂) powder having the oxidized surface was 1.0 to 20 parts by weight based on 100 parts by weight of the metal powder, the electrode connection properties of 75% or more could be implemented, and it could be confirmed that the electric properties were excellent.

As set forth above, according to embodiments of the invention, a conductive paste composition for an internal electrode may include metal powder, and Cr₂O₃ or TiO₂ powder having an average grain diameter smaller than that of the average grain diameter of the metal powder and a melting point higher than the melting point of the metal powder.

Further, the conductive paste composition may include chrome (Cr—Cr₂O₃) or titanium (Ti—TiO₂) powder having an oxidized surface.

The conductive paste composition for the internal electrode according to the embodiment of the present invention may increase a sintering shrinkage temperature of the internal electrode and may improve connection properties of the internal electrode.

In the conductive paste composition for the internal electrode according to the embodiment of the present invention, may high melting point Cr₂O₃ or TiO₂ powder or Cr—Cr₂O₃ or Ti—TiO₂ powder having an oxidized surface in the metal powder may be well dispersed, and may suppress sintering of the metal powder to about 1000° C. or more.

According to the embodiment of the present invention, when a temperature increase rate of a sintering process is controlled, the high melting point metal oxide powder in the conductive paste composition for the internal electrode may not escape between the metal powder grains but may be trapped in a grain boundaries of the metal powder. Accordingly, an agglomeration phenomenon in the internal electrode may be suppressed to increase connection properties of the internal electrode.

Further, in a region of a portion of an interface of a dielectric layer and an internal electrode layer of the ceramic electronic component, a metal layer formed by reducing a portion of chrome oxide (Cr₂O₃) or titanium oxide (TiO₂) powder may be formed. A metal layer formed by reducing a portion of chrome (Cr—Cr₂O₃) or titanium (Ti—TiO₂) powder having the oxidized surface may also be formed. The partially reduced metal layer may act as a conductor.

Further, according to the embodiment of the present invention, high melting point metal oxide powder may be included in the conductive paste for the internal electrode to trap the high melting point metal oxide powder in the internal electrodes, such that connection properties of the internal electrode may be improved to form relatively thin internal electrodes.

While the present invention has been shown and described in connection with the embodiments, it will be apparent to those skilled in the art that modifications and variations may be made without departing from the spirit and scope of the invention as defined by the appended claims.

What is claimed is:

1. A conductive paste composition for an internal electrode of a multilayer ceramic electronic component, comprising:
a metal powder; and
a chrome oxide (Cr₂O₃) or titanium oxide (TiO₂) powder having a melting point higher than the melting point of the metal powder.

2. The conductive paste composition for an internal electrode of a multilayer ceramic electronic component of claim 1, wherein a content of the Cr₂O₃ or TiO₂ powder having the melting point higher than the melting point of the metal powder is 1 to 20 parts by weight based on 100 parts by weight of the metal powder.

3. The conductive paste composition for an internal electrode of a multilayer ceramic electronic component of claim 1, wherein the metal powder is one or more selected from the group consisting of Nickel (Ni), manganese (Mn), chromium (Cr), cobalt (Co), aluminum (Al) and alloys thereof.

4. The conductive paste composition for an internal electrode of a multilayer ceramic electronic component of claim 1, wherein an average grain diameter of the metal powder is 50 to 400 nm.

5. The conductive paste composition for an internal electrode of a multilayer ceramic electronic component of claim 1, wherein an average grain diameter of the Cr₂O₃ or TiO₂ powder having the melting point higher than the melting point of the metal powder is 10 to 100 nm.

6. A conductive paste composition for an internal electrode of a multilayer ceramic electronic component, comprising:
a metal powder; and
a chrome (Cr—Cr₂O₃) or titanium (Ti—TiO₂) powder having a melting point higher than the melting point of the metal powder and an oxidized surface.

7. The conductive paste composition for an internal electrode of a multilayer ceramic electronic component of claim 6, wherein a content of the Cr—Cr₂O₃ or Ti—TiO2 powder having the melting point higher than the melting point of the metal powder and the oxidized surface is 1 to 20 parts by weight based on 100 parts by weight of the metal powder.

8. The conductive paste composition for an internal electrode of a multilayer ceramic electronic component of claim 6, wherein the metal powder is one or more selected from the group consisting of Ni, Mn, Cr, Co, Al and alloys thereof.

9. The conductive paste composition for an internal electrode of a multilayer ceramic electronic component of claim 6, wherein an average grain diameter of the metal powder is 50 to 400 nm.

10. The conductive paste composition for an internal electrode of a multilayer ceramic electronic component of claim 6, wherein an average grain diameter of the Cr—Cr₂O₃ or Ti—TiO2 powder having the melting point higher than the melting point of the metal powder and the oxidized surface is 10 to 100 nm.

11. A multilayer ceramic electronic component comprising:
a ceramic main body; and
an internal electrode layer formed in the ceramic main body,
the internal electrode layer including a Cr₂O₃ or TiO₂ powder trapped therein, the Cr₂O₃ or TiO₂ powder having a melting point higher than the melting point of metal powder forming the internal electrode layer.

12. The multilayer ceramic electronic component of claim 11, wherein the Cr₂O₃ or TiO₂ powder having the melting point higher than the melting point of the metal powder is trapped in an interface of metal powder grains forming the internal electrode layers.

13. The multilayer ceramic electronic component of claim 11, wherein the internal electrode layer includes a metal layer formed by reducing a portion of the Cr₂O₃ or TiO₂ powder having the melting point higher than the melting point of the metal powder, in one surface thereof.

14. The multilayer ceramic electronic component of claim 11, wherein the internal electrode layer is formed of a conductive paste including the metal powder and the Cr₂O₃ or TiO₂ powder having an average grain diameter that is smaller than the average grain diameter of the metal powder and the melting point higher than the melting point of the metal powder.

15. The multilayer ceramic electronic component of claim 11, wherein the ceramic main body and the internal electrode layer are simultaneously sintered.

16. A multilayer ceramic electronic component comprising:
a ceramic main body; and
an internal electrode layer formed in the ceramic main body,
the internal electrode layer including a Cr—Cr₂O₃ or Ti—TiO2 powder trapped therein, the Cr—Cr₂O₃ or Ti—TiO2 powder having a melting point higher than the melting point of metal powder forming the internal electrode layer and an oxidized surface.

17. The multilayer ceramic electronic component of claim 16, wherein the Cr—Cr₂O₃ or Ti—TiO2 powder having the melting point higher than the melting point of the metal powder and having the oxidized surface is trapped in an interface of metal powder grains forming the internal electrode layers.

18. The multilayer ceramic electronic component of claim 16, wherein the internal electrode layer includes a metal layer formed by reducing a portion of the Cr—Cr₂O₃ or Ti—TiO2 powder having the melting point higher than the melting point of the metal powder and having the oxidized surface, in one surface thereof.

19. The multilayer ceramic electronic component of claim 16, wherein the internal electrode layer is formed of a conductive paste including the metal powder and the Cr—Cr₂O₃ or Ti—TiO2 powder having an average grain diameter that is smaller than the average grain diameter of the metal powder, the melting point higher than the melting point of the metal powder, and the oxidized surface.

20. The multilayer ceramic electronic component of claim 16, wherein the ceramic main body and the internal electrode layer are simultaneously sintered.
